(19) United States
(12) Patent Application Publication
(10) Pub. No.: US 2023/0026854 A1
(43) Pub. Date: Jan. 26, 2023

(54) SYSTEM AND METHOD FOR PROVIDING A RESPONSE TO A PARALLEL SEARCH QUERY

(71) Applicant: Flipkart Internet Private Limited, Bengaluru (IN)

(72) Inventors: Vicky KUMAR, Bangalore (IN); Shubham VERMA, Rajasthan (IN)

(73) Assignee: Flipkart Internet Private Limited, Bengaluru (IN)

(21) Appl. No.: 17/868,414

(22) Filed: Jul. 19, 2022

(30) Foreign Application Priority Data
Jul. 20, 2021 (IN) 202141032696

(51) Int. Cl. G06F 16/2453; G06F 16/9535

(52) U.S. Cl. CPC G06F 16/24532; G06F 16/9535

(57) ABSTRACT

A system and method for providing a response to a parallel search query received at a digital platform. The method encompasses receiving, at the digital platform, a user query. The method thereafter comprises identifying, a plurality of entities in the user query. Further the method encompasses identifying, the user query as the parallel search query based on the identification of the plurality of entities in the user query. The method thereafter comprises generating, a user interface based on the identification of the parallel search query, wherein the user interface comprises a scrollable segment for each entity from the plurality of entities. Also, the method comprises performing, a search for said each entity. The method thereafter comprises generating, a response for said each entity based on the search performed. Further the method comprises providing, the response generated for said each entity via the scrollable segment for said each entity.

### TECHNICAL FIELD

The present invention generally relates to human-computer interaction and more particularly to systems and methods for providing a response to a parallel search query received at a digital platform.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

The advancement in digital technologies has provided users various digital platforms to avail various services associated with such digital platforms. Most of these digital platforms also provide the users, an option to initiate a search query via a search engine, to search for a product or service offered via said digital platforms. More specifically, a search query may be any query initiated by the users to search over a digital platform at least one of a product, a service, a media data and other such items. Also, it is now possible for the users to receive a suitable result to a search query posted by them on a digital platform. For instance, now a days a user can easily search a required product or service over a digital platform such as an e-commerce platform in order to further purchase said product or service via the e-commerce platform.

Mostly search queries initiated by the users are complex in nature and it is important for a digital platform to understand the search queries properly to provide a suitable search result in response to said search queries. Also, in order to provide the suitable search results for the search queries posted by the users, a number of solutions are developed over a period of time. The currently known solutions provide a single search result in response to a particular user query initiated by a user and fail to identify if said particular user query is initiated for only a single entity or there are multiple entities present in said particular user query for which a respective response/search result needs to be provided. Therefore, the currently known solutions fail to efficiently understand a user/search query posted by a user on a digital platform, in order to further identify said user query as a parallel search query (i.e. a user query with multiple entities for which a respective response/search result needs to be provided). The currently known solutions fail to provide a search result individually for each entity present in a user query comprising a plurality of entities (i.e. in a parallel search query). For instance, there are chances that a user might be looking for two or more products (entities) on an e-commerce platform, via a single search/user query posted by the user on such e-commerce platform. In the given instance, the currently known solutions fail to identify such single search/user query as a parallel search query and also the currently known solutions fails to provide a scrollable search result simultaneously for each of the product from the two or more products present in the user query.

Also, in order to provide the users a better user experience it is important to provide a search result of a user query of the users in an effective manner. Various digital platforms in order to provide the users the better user experience have developed a number of solutions. Some of the known solutions for providing a search result of a user query in an effective manner provides similar product(s) section(s) on a user interface along with the search results of said user query, wherein the similar product(s) section(s) comprises one or more products/entities similar to a product/entity for which the user query is initiated by the user. The similar product(s) section(s) provided by the currently known solutions are controlled by the digital platform(s) and therefore the currently known solutions fail to provide a direct scrollable user query based search result for each entity present in a user query with multiple entities, via scrollable sections/segments on a user interface.

Therefore, there are a number of limitations of the currently known solutions and there is a need in the art to provide a solution to provide a response to a parallel search query received at a digital platform in an effective and efficient manner.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to identify a user query received at a digital platform as a parallel search query based on a presence of multiple entities in the user query. Another object of the present invention is to provide a method and system for providing a response to an identified parallel search query in an effective and efficient manner. Also an object of the present invention is to provide a search result/response for each entity from a plurality of entities present in the parallel search query. Further an object of the present invention is to provide a scrollable segment on a user interface for each entity present in a parallel search query. Another object of the present invention is to provide a search result generated for each entity from a plurality of entities present in the parallel search query via a scrollable segment provided for said each entity on a user interface. Further an object of the present invention is to provide a user interface for providing simultaneously various search results generated for two or more entities present in a user query. Also, an object of the present invention is to provide search result/response for each entity from a plurality of entities present in the parallel search query, in an augmented reality (AR) environment via scrollable segment provided for said each entity on a user interface. Yet another object of the present invention is to provide a search result/response generated for one or more entities from a plurality of entities present in the parallel search query, via a mannequin of a user created on a user interface.

Furthermore, in order to achieve the aforementioned objectives, the present invention provides a method and system for providing a response to a parallel search query received at a digital platform.

A first aspect of the present invention relates to the method for providing a response to a parallel search query received at a digital platform. The method comprises receiving, by an input unit at the digital platform, a user query of a user, wherein the user query is received via one of a first search engine and a second search engine. The method thereafter comprises identifying, by an identification unit, a plurality of entities in the user query. Further the method encompasses identifying, by the identification unit, the user query as the parallel search query based on the identification of the plurality of entities in the user query. The method thereafter comprises generating, by a processing unit, a user interface based on the identification of the parallel search query, wherein the user interface comprises a scrollable segment for each entity from the plurality of entities. Also, the method comprises performing, by the processing unit, a search for said each entity from the plurality of entities. The method thereafter comprises generating, by the processing unit, a response for said each entity from the plurality of entities based on the search performed for said each entity. Further the method comprises providing, by an output unit, the response generated for said each entity from the plurality of entities via the scrollable segment for said each entity.

Another aspect of the present invention relates to a system for providing a response to a parallel search query received at a digital platform. The system comprises an input unit, configured to receive at the digital platform, a user query of a user, wherein the user query is received via one of a first search engine and a second search engine. Also, the system comprises an identification unit, configured to identify, a plurality of entities in the user query. The identification unit is also configured to identify, the user query as the parallel search query based on the identification of the plurality of entities in the user query. Further the system comprises a processing unit, configured to generate, a user interface based on the identification of the parallel search query, wherein the user interface comprises a scrollable segment for each entity from the plurality of entities. The processing unit is thereafter configured to perform, a search for said each entity from the plurality of entities. Further the processing unit is configured to generate, a response for said each entity from the plurality of entities based on the search performed for said each entity. The system further comprises an output unit, configured to provide, the response generated for said each entity from the plurality of entities via the scrollable segment for said each entity.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for providing a response to a parallel search query received at a digital platform, in accordance with exemplary embodiments of the present invention.

FIG. 2 illustrates an exemplary method flow diagram [200], for providing a response to a parallel search query received at a digital platform, in accordance with exemplary embodiments of the present invention.

FIG. 3 illustrates three exemplary user interfaces [302 A], [302 B] and [302 C] for providing a response to a parallel search query received at a digital platform, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a processing unit, an input unit, an output unit, an identification unit, a storage unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section the existing technologies have many limitations and in order to overcome at least some of the limitations of the prior known solutions, the present disclosure provides a solution for providing a response to a parallel search query received at a digital platform. More particularly, the present invention in order to provide the response to the parallel search query received at the digital platform firstly encompasses identifying a user/search query received at the digital platform as the parallel search query. The user query received at the digital platform is identified as the parallel search query based on an identification of multiple entities such as multiple products in the user query. The identification of the multiple entities in the user query indicates that the user query is initiated to obtain simultaneously a search result for each entity from the multiple entities and hence the user query is identified as the parallel search query. Further, once the user query is identified as the parallel search query, the present invention encompasses generating a user interface comprising of a scrollable segment for each entity from the plurality of entities (i.e. the multiple entities) present in the parallel search query. The present invention thereafter encompasses generating a search result for the each entity from the plurality of entities based on a search performed for the each entity. Once the search result for the each entity from the plurality of entities is generated the same is provided via the scrollable segment of said respective each entity. In an implementation, the present invention also encompasses providing the generated search result for the each entity from the plurality of entities in an augmented reality environment. Also, in another implementation, the present invention also encompasses providing the generated search result for the each entity from the plurality of entities via a mannequin of a user, wherein the mannequin of the user is generated on the user interface based on one or more user identification parameters.

Therefore, based on the implementation of the features of the present invention, a search result for multiple entities present in a single user query is provided simultaneously over a user interface via a unique scrollable segment for each entity. The present invention provides a technical effect at least by providing simultaneously on a user interface at a user device, a scrollable search result for each entity from multiple entities present in a single user query. Also, the present invention provides a technical advancement over currently known solutions at least by providing a search result for multiple entities simultaneously over a user interface at a user device, via a unique scrollable segment for each entity from the multiple entities, wherein the multiple entities are identified in a single user query. Furthermore, the present invention also provides technical advancement over currently known solutions by providing simultaneously in an augmented reality environment, a scrollable search result for each entity from multiple entities identified in a single user query. The present invention in an implementation also provides technical advancement over currently known solutions by providing a search result for one or more entities identified in a single user/parallel search query, via a mannequin of a user generated on a user interface. Therefore, the present invention provides an efficient and effective solution for providing a response to a parallel search query received at a digital platform.

Hereinafter, exemplary embodiments of the present disclosure will be described in detail with reference to the accompanying drawings so that those skilled in the art can easily carry out the present disclosure.

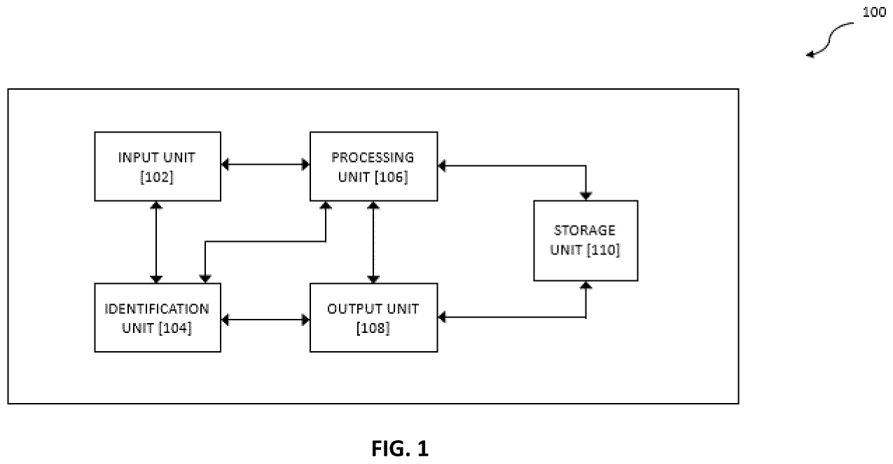

Referring to FIG. 1, an exemplary block diagram of a system [100] for providing a response to a parallel search query received at a digital platform is shown. The system [100] comprises at least one input unit [102], at least one identification unit [104], at least one processing unit [106], at least one output unit [108] and at least one storage unit [110]. Also, all of the components/units of the system [100] are assumed to be connected to each other unless otherwise indicated below. Also, in FIG. 1 only a few units are shown, however, the system [100] may comprise multiple such units or the system [100] may comprise any such numbers of said units, as required to implement the features of the present disclosure. Further, in an implementation, the system [100] may be configured at, at least one of a server level and a device level to implement the features of the present invention.

The system [100] is configured to provide the response to the parallel search query received at the digital platform, with the help of the interconnection between the components/units of the system [100].

The input unit [102] of the system [100] is configured to receive at the digital platform, a user query of a user, wherein the user query is received via one of a first search engine and a second search engine. The user query is a search query initiated by the user from a user device via one of the first search engine and the second search engine, wherein said search query is initiated by the user from the user device to receive a search result corresponding to one or more entities present in said search query. Further each entity present in the user query is one of a product, a service and other such facility provided by the digital platform. Also, in a preferred implementation the digital platform may be an e-commerce platform. Further, the first search engine is a search engine configured to receive the user query as single search string and the second search engine is a search engine configured to receive the user query as two or more search strings. Therefore, the user query is received as the single search string at the first search engine and the user query is received as the two or more search strings at the second search engine. Furthermore, the user query received via the second search engine is a combination of the two or more search strings. In an example, the input unit [102] of the system [100] may be configured to receive at an ecommerce platform via a first search engine a user query as a single search string “blue ABC jeans and CBA white shirt”, wherein ABC and CBA may be any brand name. Also, in another example, the input unit [102] of the system [100] may be configured to receive at an ecommerce platform via a second search engine a user input as two search strings “blue ABC jeans” and “CBA white shirt”, wherein ABC and CBA may be any brand name and a combination of both search strings “blue ABC jeans, CBA white shirt” may be the user query. Also, in an implementation in order to receive the user query as the two or more search strings at the second search engine, two or more input tabs may be provided at the second search engine and in order to receive the user query as the single search string at the first search engine, a single input tab may be provided at the first search engine.

The input unit [102] of the system [100] is connected to the identification unit [104] and once the user query of the user is received at the digital platform by the input unit [102], the input unit [102] is further configured to provide the user query to the identification unit [104]. The identification unit [104] is configured to identify, a plurality of entities in the user query, wherein the plurality of entities are identified in the user query based on a first pre-trained dataset. The first pre-trained dataset is a dataset trained based on a plurality of data associated with a plurality of entities. In an implementation, in order to identify, the plurality of entities in the user query, the identification unit [104] is configured to analyze the user query based on the first pre-trained dataset. Considering the above stated example, where the user query is “blue ABC jeans and CBA white shirt”, in the given instance the identification unit [104] is configured to analyze the user query “blue ABC jeans and CBA white shirt” based on the first pre-trained dataset i.e. the dataset trained based on the plurality of data associated with the plurality of entities. Also, based on the analyses the identification unit [104] may be configured to identify “blue ABC jeans” (i.e. a product jeans of ABC brand and blue colour) as a first entity and “CBA white shirt” (i.e. a product shirt of CBA brand and white colour) as a second entity, therefore in the given instance the identification unit [104] is configured to identify two entities (i.e. the plurality of entities) in the user query. Further the identification unit [104] is configured to identify, the user query as the parallel search query based on the identification of the plurality of entities in the user query. More particularly, the identification of the plurality of entities in the user query indicates that the user query is received to provide simultaneously a search result for each entity from the plurality of entities and hence the user query is identified as the parallel search query. Considering the above stated example, where for the user query is “blue ABC jeans and CBA white shirt”, the plurality of entities i.e. “blue ABC jeans” (i.e. the product jeans of ABC brand and blue colour) and “CBA white shirt” (i.e. the product shirt of CBA brand and white colour) are identified by the identification unit [104], in the given instance based on the identification of the two entities “blue ABC jeans” and “CBA white shirt” (i.e. the plurality of entities), the identification unit [104] is configured to identify, the user query “blue ABC jeans and CBA white shirt” as the parallel search query.

Furthermore, the input unit [102] and identification unit [104] of the system [100] are connected to the processing unit [106] and once the user query is identified as the parallel search query, the identification unit [104] is configured to provide the user query as the parallel search query to the processing unit [106]. The processing unit [106] is then configured to generate, a user interface based on the identification of the parallel search query, wherein the user interface comprises a scrollable segment for each entity from the plurality of entities present in the parallel search query. Considering the above stated example, where the user query “blue ABC jeans and CBA white shirt” is identified as the parallel search query, the processing unit [106] in the given example is configured to generate, a user interface at least comprises of a scrollable segment for each entity of the two entities “blue ABC jeans” and “CBA white shirt” (i.e. the plurality of entities) present in the user/parallel search query “blue ABC jeans and CBA white shirt”.

Also, once the user query as the parallel search query is received at the processing unit [106], the processing unit [106] is also configured to perform, a search for each entity from the plurality of entities present in the received parallel search query. Considering the above stated example, where the user query “blue ABC jeans and CBA white shirt” is identified as the parallel search query, the processing unit [106] in the given example is also configured to perform a search for each entity of the two entities “blue ABC jeans” and “CBA white shirt” present in the received parallel search query “blue ABC jeans and CBA white shirt”

Thereafter the processing unit [106] is configured to generate, a response for said each entity from the plurality of entities based on the search performed for said each entity. The generation of the response for said each entity from the plurality of entities is further based on a second pre-trained dataset. The second pre-trained dataset is a dataset trained based on a plurality of search queries initiated for a plurality of entities and their corresponding search results/responses. More particularly, in order to generate the response for the each entity from the plurality of entities, once the search is performed for said each entity, the processing unit [106] is firstly configured to analyze the each entity from the plurality of entities present in the received parallel search query based on the second pre-trained dataset i.e. the dataset trained based on the plurality of search queries initiated for the plurality of entities and their corresponding search results/responses. Further based on said analysis of the each entity from the plurality of entities, the processing unit [106] is configured to generate the response/search result for the each entity from the plurality of entities. Considering the above stated example, where the processing unit [106] is configured to perform the search for each entity of the two entities “blue ABC jeans” and “CBA white shirt” present in the received parallel search query “blue ABC jeans and CBA white shirt” in the given instance once the search is initiated for the each entity of the two entities “blue ABC jeans” and CBA white shirt”, the processing unit is firstly configured to analyze the each entity from the two entities “blue ABC jeans” and “CBA white shirt” based on the second pre-trained dataset i.e. the dataset trained based on the plurality of search queries initiated for the plurality of entities and their corresponding search results/responses. Thereafter based on the analysis of the each entity from the two entities “blue ABC jeans” and “CBA white shirt”, the processing unit [106] is configured to generate the response/search result for the each entity from the two entities “blue ABC jeans” and “CBA white shirt”. For instance, in the given example the generated response/search result for the entity “blue ABC jeans” may comprise one or more blue colour jeans of ABC brand present in a catalog of the digital platform (ecommerce platform) on which the user query is received and the generated response/search result for the entity “CBA white shirt” may comprise one or more white colour shirt of CBA brand present in the catalog of the digital platform (ecommerce platform).

Furthermore, the input unit [102], identification unit [104] and processing unit [106] of the system [100] are connected to the output unit [108] and once the response for the each entity from the plurality of entities is generated based on the search performed for said each entity, the processing unit [106] is configured to provide said response generated for the each entity from the plurality of entities to the output unit [108]. Further the output unit [108] is configured to provide, the response generated for said each entity from the plurality of entities via the scrollable segment for said each entity. In an implementation the response generated for said each entity from the plurality of entities is further provided by displaying by the output unit [108], said response generated for said each entity from the plurality of entities on the user interface via the scrollable segment for said each entity. In an implementation, if the system [100] is configured at the server level, the output unit [108] is configured to transmit/provide the response generated for the each entity from the plurality of entities to the user device of the user along with a configuration for the generated user interface, via a transmitter unit, wherein the response generated for the each entity is further provided at the user device on the user interface via the scrollable segment for said each entity. Also, in an implementation, if the system is configured at the device level, the output unit [108] such as a display unit at the user device is configured to provide/display the response generated for the each entity from the plurality of entities over the user interface via the scrollable segment for said each entity. Further, considering the above stated example, where the processing unit [106] is configured to generate the response/search result i.e. the one or more blue colour jeans of ABC brand for the entity “blue ABC jeans” and the response/search result i.e. the one or more white colour shirt of CBA brand for the entity “CBA white shirt”, the output unit [108] in the given instance is configured to provide the response i.e. the one or more blue colour jeans of ABC brand via a scrollable segment for the entity “blue ABC jeans” present on the user interface. Also, the output unit [108] in the given instance is configured to provide the response i.e. the one or more white colour shirt of CBA brand via a scrollable segment for the entity “CBA white shirt” present on the user interface. In an implementation the response generated for said each entity “blue ABC jeans” and “CBA white shirt” is further provided by displaying by the output unit [108], said response generated for the each entity “blue ABC jeans” and “CBA white shirt” via the scrollable segment for “blue ABC jeans” and “CBA white shirt” respectively, present on the user interface at the user device.

Also, in another implementation the response generated for said each entity from the plurality of entities may be further provided by the output unit [108] in an augmented reality (AR) environment via the scrollable segment for said each entity from the plurality of entities. For example, if a parallel search query is “white table and white chair”, a response generated for each entity i.e. for “white table” and “white chair” present in the parallel search/user query “white table and white chair” may be further provided in an (AR) environment via a scrollable segment for the each entity “white table” and “white chair”, respectively. More particularly, in the (AR) environment one or more white tables via a scrollable segment present on a user interface for the entity “white table” and one or more “white chair” for a scrollable segment present on the user interface for the entity “white chair” may be provided based on the implementation of the features of the present invention.

Also, in an implementation the processing unit [106] is further configured to generate, at the user interface, at least one segment for at least one pre-selected entity based on a receipt of a user input to generate said at least one segment for the at least one pre-selected entity. Each pre-selected entity from the at least one pre-selected entity may be one of a product, a service and such other element pre-selected by the user. For example, a product added in a cart by a user on an e-commerce platform may be a pre-selected entity. Once the at least one segment for the at least one pre-selected entity is generated at the user interface, the processing unit [106] is configured to display, at the user interface, the at least one pre-selected entity in the at least one segment generated for the at least one pre-selected entity. For example, if a pre-selected entity is a shirt added by a user in a cart over an e-commerce platform, the processing unit [106] in the given example may be configured to generated for said shirt a segment on a user interface based on a receipt of a user input to generate for said shirt the segment on the user interface. Once the segment for said shirt is generated on the user interface, the processing unit [106] is further configured to display at the user interface said shirt in the generated segment for said shirt.

In one implementation the input unit [102] is further configured to receive, one or more user identification parameters. The one or more user identification parameters are one or more parameters indicating one or more features of the user. For instance, a user identification parameter may be a parameter such as a height of the user, a weight of the user, a colour tone of the user, an eye color of the user, a hair color of the user, a hair pattern of the user, a facial feature of the user or the like. Once the one or more user identification parameters are received, the processing unit [106] is further configured to create, a mannequin for the user based on the one or more user identification parameters, wherein the mannequin is created on the user interface. Also, in the given implementation the response for said each entity from the plurality of entities is further provided by the output unit [108] via the mannequin. Considering the above stated example, where the processing unit [106] is configured to generate the response i.e. the one or more blue colour jeans of ABC brand for the entity “blue ABC jeans” and the response i.e. the one or more white colour shirt of CBA brand for the entity “CBA white shirt”, the output unit [108] in the given instance is configured to provide the response i.e. at least one of a blue colour jeans from the one or more blue colour jeans of ABC brand and a white colour shirt from the one or more white colour shirt of CBA brand via a mannequin generated for a user on the user interface.

Therefore, based on the implementation of the features of the present invention a search result for each entity from two or more entities present in a user query/a parallel search query, is provided simultaneously in a scrollable manner such that the search result for the each entity may be provided and scrolled in a scrollable segment unique to the each entity provided over a user interface of a user device. The search result for the each entity from the two or more entities provided/displayed simultaneously in the respective scrollable segment of the each entity provides a better user experience for the user by allowing the user to match multiple entities (such as items to be ordered via an ecommerce platform) efficiently and effectively. Furthermore, as the multiple search results are provided simultaneously for the multiple entities present in the parallel search query, the user may select and/or buy multiple products/entities together over the e-commerce platform. Further, in an implementation based on a selection and/or buying of multiple entities together, by one or more users based on a search result provided for a parallel search query, a dataset may be generated in order to further provide multiple search results for multiple entities present in one or more new parallel search queries, in a matching order generated based on the generated dataset.

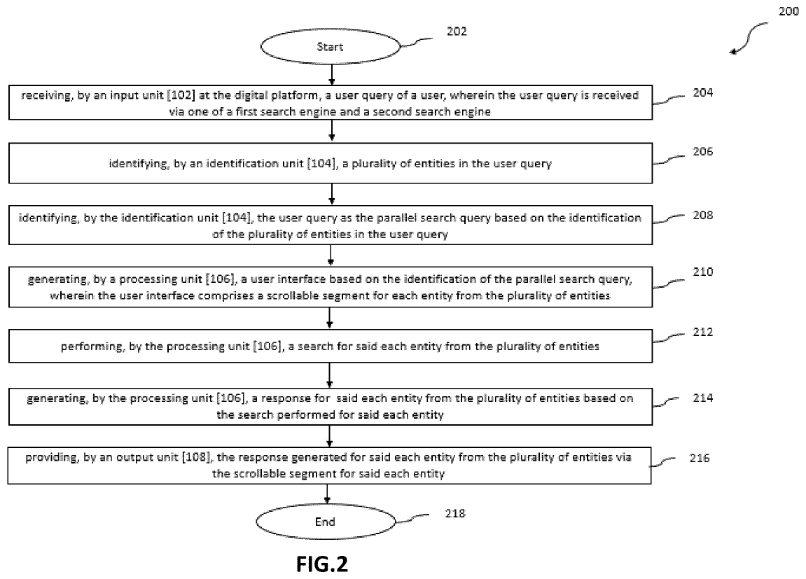

Referring to FIG. 2 an exemplary method flow diagram [200], for providing a response to a parallel search query received at a digital platform, in accordance with exemplary embodiments of the present invention is shown. In an implementation the method is performed by the system [100]. Further, in an implementation, the method may be performed at, at least one of a server level and a device level to implement the features of the present invention. Also, as shown in FIG. 2, the method starts at step [202].

At step [204] the method comprises receiving, by an input unit [102] at the digital platform, a user query of a user, wherein the user query is received via one of a first search engine and a second search engine. The user query is a search query initiated by the user from a user device via one of the first search engine and the second search engine, wherein said search query is initiated by the user from the user device to receive a search result corresponding to one or more entities present in said search query. Further each entity present in the user query is one of a product, a service and other such facility provided by the digital platform. Also, in a preferred implementation the digital platform may be an e-commerce platform. Further, the first search engine is a search engine configured to receive the user query as single search string and the second search engine is a search engine configured to receive the user query as two or more search strings. Therefore, the user query is received as the single search string at the first search engine and the user query is received as the two or more search strings at the second search engine. Furthermore, the user query received via the second search engine is a combination of the two or more search strings. In an example, the method encompasses receiving by the input unit [102] at an ecommerce platform via a first search engine a user query as a single search string “blue XYZ shoe and ZYX white t-shirt”, wherein XYZ and ZYX may be any brand name. Also, in another example, the method encompasses receiving by the input unit [102], at an ecommerce platform via a second search engine a user input as two search strings “blue XYZ shoe” and “ZYX white t-shirt”, wherein XYZ and ZYX may be any brand name and a combination of both search strings such as “blue XYZ shoe and ZYX white t-shirt” may be the user query. Also, in an implementation in order to receive the user query as the two or more search strings at the second search engine, two or more input tabs may be provided at the second search engine and in order to receive the user query as the single search string at the first search engine, a single input tab may be provided at the first search engine.

Once the user query of the user is received at the digital platform by the input unit [102], the method encompasses providing by the input unit [102], the user query to an identification unit [104]. Further, at step [206] the method comprises identifying, by the identification unit [104], a plurality of entities in the user query, wherein the plurality of entities are identified in the user query based on a first pre-trained dataset. The first pre-trained dataset is a dataset trained based on a plurality of data associated with a plurality of entities. In an implementation, in order to identify, the plurality of entities in the user query, the method encompasses analyzing by the identification unit [104], the user query based on the first pre-trained dataset. Considering the above stated example, where the user query is “blue XYZ shoe and ZYX white t-shirt”, in the given instance the method comprises analyzing by the identification unit [104] the user query “blue XYZ shoe and ZYX white t-shirt” based on the first pre-trained dataset i.e. the dataset trained based on the plurality of data associated with the plurality of entities. Also, based on the analysis the method may comprises identifying by the identification unit [104] “blue XYZ shoe” (i.e. a product shoe of XYZ brand and blue colour) as a first entity and “ZYX white t-shirt” (i.e. a product t-shirt of ZYX brand and white colour) as a second entity, therefore in the given instance the method comprises identifying by the identification unit [104], two entities (i.e. the plurality of entities) in the user query.

Further, at step [208] the method comprises identifying, by the identification unit [104], the user query as the parallel search query based on the identification of the plurality of entities in the user query. More particularly, the identification of the plurality of entities in the user query indicates that the user query is received to provide simultaneously a search result for each entity from the plurality of entities and hence the user query is identified as the parallel search query based on the identification of the plurality of entities in the user query. Considering the above stated example, where for the user query is “blue XYZ shoe and ZYX white t-shirt”, the plurality of entities i.e. “blue XYZ shoe” and “ZYX white t-shirt” are identified by the identification unit [104], in the given instance based on the identification of the two entities “blue XYZ shoe” and “ZYX white t-shirt” (i.e. the plurality of entities), the method encompasses identifying by the identification unit [104], the user query “blue XYZ shoe and ZYX white t-shirt” as the parallel search query.

Once the user query is identified as the parallel search query, the method comprises providing by the identification unit [104], the user query as the parallel search query to the processing unit [106]. Thereafter, at step [210] the method comprises generating, by the processing unit [106], a user interface based on the identification of the parallel search query, wherein the user interface comprises a scrollable segment for each entity from the plurality of entities present in the parallel search query. Considering the above stated example, where the user query “blue XYZ shoe and ZYX white t-shirt” is identified as the parallel search query, the method via the processing unit [106] in the given example encompasses generating, a user interface at least comprises of a scrollable segment for each entity of the two entities “blue XYZ shoe” and “ZYX white t-shirt” (i.e. the plurality of entities) present in the user/parallel search query “blue XYZ shoe and ZYX white t-shirt”.

Also, once the user query as the parallel search query is received at the processing unit [106], the method at step [212] also comprises performing, by the processing unit [106], a search for the each entity from the plurality of entities present in the received parallel search query. Considering the above stated example, where the user query “blue XYZ shoe and ZYX white t-shirt” is identified as the parallel search query, the method in the given example also comprises performing by the processing unit [106], a search for each entity of the two entities “blue XYZ shoe” and “ZYX white t-shirt” present in the received parallel search query “blue XYZ shoe and ZYX white t-shirt”.

Next, at step [214] the method comprises generating, by the processing unit [106], a response for said each entity from the plurality of entities based on the search performed for said each entity. The generation of the response for said each entity from the plurality of entities is further based on a second pre-trained dataset. The second pre-trained dataset is a dataset trained based on a plurality of search queries initiated for a plurality of entities and their corresponding search results/responses. More particularly, in order to generate the response for the each entity from the plurality of entities, once the search is performed for said each entity, the method firstly comprises analyzing by the processing unit [106], the each entity from the plurality of entities present in the received parallel search query based on the second pre-trained dataset i.e. the dataset trained based on the plurality of search queries initiated for the plurality of entities and their corresponding search results/responses. Further based on said analysis of the each entity from the plurality of entities, the method comprises generating by the processing unit [106], the response/search result for the each entity from the plurality of entities. Considering the above stated example, where the method encompasses performing by the processing unit [106] the search for each entity of the two entities “blue XYZ shoe” and “ZYX white t-shirt” present in the received parallel search query “blue XYZ shoe and ZYX white t-shirt”, in the given instance once the search is initiated for the each entity of the two entities “blue XYZ shoe” and “ZYX white t-shirt”, the method comprises analyzing by the processing unit [106], the each entity from the two entities “blue XYZ shoe” and “ZYX white t-shirt” based on the second pre-trained dataset i.e. the dataset trained based on the plurality of search queries initiated for the plurality of entities and their corresponding search results/responses. Thereafter based on the analysis of the each entity from the two entities “blue XYZ shoe” and “ZYX white t-shirt” the method comprises generating by the processing unit [106], the response/search result for the each entity from the two entities “blue XYZ shoe” and “ZYX white t-shirt”. For instance, in the given example the generated response/search result for the entity “blue XYZ shoe” may comprise one or more blue colour shoe of XYZ brand present in a catalog of the digital platform (ecommerce platform) on which the user query is received and the generated response/search result for the entity “ZYX white t-shirt” may comprise one or more white colour t-shirt of ZYX brand present in the catalog of the digital platform (ecommerce platform).

Once the response for the each entity from the plurality of entities is generated based on the search performed for said each entity, the method comprises providing by the processing unit [106] said response generated for the each entity from the plurality of entities to an output unit [108]. Thereafter, at step [216] the method comprises providing, by the output unit [108], the response generated for said each entity from the plurality of entities via the scrollable segment for said each entity. In an implementation the response generated for said each entity from the plurality of entities is further provided by displaying by the output unit [108], said response generated for said each entity from the plurality of entities on the user interface via the scrollable segment for said each entity. In an implementation, if the method is performed at the server level, the method encompasses providing/transmitting by the output unit [108], the response generated for the each entity from the plurality of entities to the user device of the user along with a configuration for the generated user interface, via a transmitter unit, wherein the response generated for the each entity is further provided at the user device on the user interface via the scrollable segment for said each entity. Also, in an implementation, if the method is performed at the device level, the method via the output unit [108] such as a display unit at the user device, encompasses providing/displaying the response generated for the each entity from the plurality of entities over the user interface via the scrollable segment for said each entity. Further, considering the above stated example, where the method comprises generating by the processing unit [106], the response/search result i.e. the one or more blue colour shoe of XYZ brand for the entity “blue XYZ shoe” and the response/search result i.e. the one or more white colour t-shirt of ZYX brand for the entity “ZYX white t-shirt”, the method via the output unit [108] in the given instance comprises providing the response i.e. the one or more blue colour shoe of XYZ brand via a scrollable segment for the entity “blue XYZ shoe” present on the user interface. Also, the method via the output unit [108] in the given instance comprises providing the response i.e. the one or more white colour t-shirt of ZYX brand via a scrollable segment for the entity “ZYX white t-shirt” present on the user interface. In an implementation the response generated for said each entity “blue XYZ shoe” and “ZYX white t-shirt” is further provided by displaying by the output unit [108], said response generated for the each entity “blue XYZ shoe” and “ZYX white t-shirt” via the scrollable segment for “blue XYZ shoe” and “ZYX white t-shirt” respectively, present on the user interface at the user device.

Also, in another implementation the response generated for said each entity from the plurality of entities is further provided by the output unit [108] in an augmented reality (AR) environment via the scrollable segment for said each entity from the plurality of entities. For example, if a parallel search query is “blue table and white bed”, a response generated for each entity i.e. for “blue table” and “white bed” present in the parallel search/user query “blue table and white bed” may be further provided in an (AR) environment via a scrollable segment for the each entity “blue table” and “white bed”, respectively. More particularly, in the (AR) environment one or more blue tables via a scrollable segment present on a user interface for the entity “blue table” and one or more “white bed” for a scrollable segment present on the user interface for the entity “white bed” may be provided based on the implementation of the features of the present invention. Also, in an implementation the method further comprises generating, by the processing unit [106] at the user interface, at least one segment for at least one pre-selected entity based on a receipt of a user input to generate said at least one segment for the at least one pre-selected entity. Each pre-selected entity from the at least one pre-selected entity may be one of a product, a service and such other element pre-selected by the user. Once the at least one segment for the at least one pre-selected entity is generated at the user interface, the method leads to displaying, by the processing unit [106] at the user interface, the at least one pre-selected entity in the at least one segment generated for the at least one pre-selected entity. For example, if a pre-selected entity is a chair added by a user in a cart over an e-commerce platform, the method via the processing unit [106] in the given example may comprises generating for said chair a segment on a user interface based on a receipt of a user input to generate for said chair the segment on the user interface. Once the segment for said chair is generated on the user interface, the method further encompasses displaying by the processing unit [106], at the user interface said chair in the generated segment for said chair.

In one implementation the method also encompasses receiving, at the input unit [102], one or more user identification parameters. The one or more user identification parameters are one or more parameters indicating one or more features of the user. For instance, a user identification parameter may be a parameter such as a height of the user, a weight of the user, a colour tone of the user, an eye color of the user, a hair color of the user, a hair pattern of the user, a facial feature of the user or the like. Once the one or more user identification parameters are received, the method thereafter leads to creating, by the processing unit [106], a mannequin for the user based on the one or more user identification parameters, wherein the mannequin is created on the user interface. Also, in the given implementation the response for the each entity from the plurality of entities is further provided by the output unit [108] via the mannequin. Considering the above stated example, where the method encompasses generating by the processing unit [106] the response i.e. the one or more blue colour shoe of XYZ brand for the entity “blue XYZ shoe” and the response i.e. the one or more white colour t-shirt of ZYX brand for the entity “ZYX white t-shirt”, the method via the output unit [108] in the given instance comprises providing the response i.e. at least one of a blue colour shoe from the one or more blue colour shoe of XYZ brand and a white colour t-shirt from the one or more white colour t-shirt of ZYX brand via a mannequin generated for a user on the user interface.

Further, after providing the response to the parallel search query received at the digital platform, the method terminates at step [218].

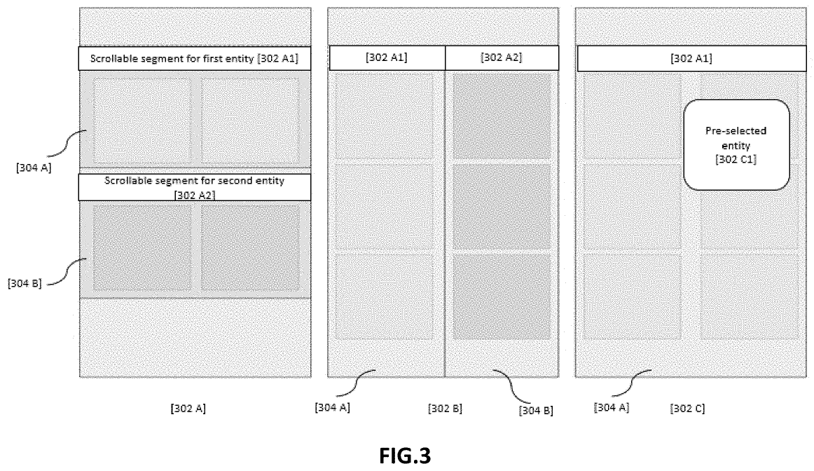

Referring to FIG. 3, three exemplary user interfaces [302 A], [302 B] and [302 C] for providing a response to a parallel search query received at a digital platform, in accordance with exemplary embodiments of the present invention is shown. The parallel search query may be a search query comprising two entities i.e. a first entity and a second entity.

The user interface [302 A] at [302 A1] depicts a scrollable segment for the first entity and the user interface [302 A] at [304 A] depicts a search result for the first entity provided via the scrollable segment for the first entity. Also, the user interface [302 A] at [302 A2] depicts a scrollable segment for the second entity and the user interface [302 A] at [304 B] depicts a search result for the second entity provided via the scrollable segment for the second entity.

The user interface [302 B] at [302 A1] depicts a scrollable segment for the first entity and the user interface [302 B] at [304 A] depicts a search result for the first entity provided via the scrollable segment for the first entity. Also, the user interface [302 B] at [302 A2] depicts a scrollable segment for the second entity and the user interface [302 B] at [304 B] depicts a search result for the second entity provided via the scrollable segment for the second entity.

The user interface [302 C] at [302 A1] depicts a scrollable segment for the first entity and the user interface [302 C] at [304 A] depicts a search result for the first entity provided via the scrollable segment for the first entity. Also, the user interface [302 C] at [302 C1] depicts a pre-selected entity in a segment generated for said pre-selected entity based on the implementation of the features of the present invention.

Thus, the present invention provides a novel solution for providing a response to a parallel search query received at a digital platform. Also, based on the implementation of the features of the present invention, a search result for multiple entities present in a single user query is provided simultaneously over a user interface at a user device, via a unique scrollable segment for each entity. The present invention provides a technical effect at least by providing simultaneously a scrollable search result for each entity from multiple entities present in a single user query. Also, the present invention provides a technical advancement over currently known solutions at least by providing a search result for multiple entities simultaneously over a user interface via a unique scrollable segment for each entity from the multiple entities, wherein the multiple entities are identified in a single user query. Furthermore, the present invention also provides technical advancement over currently known solutions by providing simultaneously in an augmented reality environment, a scrollable search result for multiple entities identified in a single user query. In an implementation the present invention also provides technical advancement over currently known solutions by providing a search result for one or more entities (such as clothes, apparels, shoes and the like) identified in a single user query via a mannequin of a user, wherein the mannequin of the user is generated based on one or more user identification parameters.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

1. A method for providing a response to a parallel search query received at a digital platform, the method comprising:
receiving, by an input unit [102] at the digital platform, a user query of a user, wherein the user query is received via one of a first search engine and a second search engine;
identifying, by an identification unit [104], a plurality of entities in the user query;
identifying, by the identification unit [104], the user query as the parallel search query based on the identification of the plurality of entities in the user query;
generating, by a processing unit [106], a user interface based on the identification of the parallel search query, wherein the user interface comprises a scrollable segment for each entity from the plurality of entities;
performing, by the processing unit [106], a search for said each entity from the plurality of entities;
generating, by the processing unit [106], a response for said each entity from the plurality of entities based on the search performed for said each entity; and
providing, by an output unit [108], the response generated for said each entity from the plurality of entities via the scrollable segment for said each entity.

2. The method as claimed in claim 1, wherein the response generated for said each entity from the plurality of entities is further provided by displaying by the output unit [108], said response generated for said each entity from the plurality of entities on the user interface via the scrollable segment for said each entity.

3. The method as claimed in claim 1, wherein the user query is received as a single search string at the first search engine.

4. The method as claimed in claim 1, wherein the user query is received as two or more search strings at the second search engine.

5. The method as claimed in claim 4, wherein the user query received via the second search engine is a combination of the two or more search strings.

6. The method as claimed in claim 1, the method further comprises:
generating, by the processing unit [106] at the user interface, at least one segment for at least one pre-selected entity; and
displaying, by the processing unit [106] at the user interface, the at least one pre-selected entity in the at least one segment generated for the at least one pre-selected entity.

7. The method as claimed in claim 1, wherein the plurality of entities are identified in the user query based on a first pre-trained dataset.

8. The method as claimed in claim 1, wherein the generation of the response for said each entity from the plurality of entities is further based on a second pre-trained dataset.

9. The method as claimed in claim 1, wherein the method is implemented at, at least one of a server level and a device level.

10. The method as claimed in claim 1, wherein the response generated for said each entity from the plurality of entities is further provided by the output unit [108] in an augmented reality environment via the scrollable segment for said each entity from the plurality of entities.

11. The method as claimed in claim 1, the method further comprises:
receiving, at the input unit [102], one or more user identification parameters; and
creating, by the processing unit [106], a mannequin for the user based on the one or more user identification parameters, wherein the mannequin is created on the user interface.

12. The method as claimed in claim 10, wherein the response for said each entity from the plurality of entities is further provided by the output unit [108] via the mannequin.

13. A system for providing a response to a parallel search query received at a digital platform, the system comprising:
an input unit [102], configured to receive at the digital platform, a user query of a user, wherein the user query is received via one of a first search engine and a second search engine;
an identification unit [104], configured to:
identify, a plurality of entities in the user query; and
identify, the user query as the parallel search query based on the identification of the plurality of entities in the user query;
a processing unit [106], configured to:
generate, a user interface based on the identification of the parallel search query, wherein the user interface comprises a scrollable segment for each entity from the plurality of entities;
perform, a search for said each entity from the plurality of entities; and
generate, a response for said each entity from the plurality of entities based on the search performed for said each entity; and
an output unit [108], configured to provide, the response generated for said each entity from the plurality of entities via the scrollable segment for said each entity.

14. The system as claimed in claim 13, wherein the response generated for said each entity from the plurality of entities is further provided by displaying by the output unit [108], said response generated for said each entity from the plurality of entities on the user interface via the scrollable segment for said each entity.

15. The system as claimed in claim 13, wherein the user query is received as a single search string at the first search engine.

16. The system as claimed in claim 13, wherein the user query is received as two or more search strings at the second search engine.

17. The system as claimed in claim 16, wherein the user query received via the second search engine is a combination of the two or more search strings.

18. The system as claimed in claim 13, wherein the processing unit [106] is further configured to:
generate, at the user interface, at least one segment for at least one pre-selected entity; and
display, at the user interface, the at least one pre-selected entity in the at least one segment generated for the at least one pre-selected entity.

19. The system as claimed in claim 13, wherein the plurality of entities are identified in the user query based on a first pre-trained dataset.

20. The system as claimed in claim 13, wherein the generation of the response for said each entity from the plurality of entities is further based on a second pre-trained dataset.

21. The system as claimed in claim 13, wherein the system is configured at, at least one of a server level and a device level.

22. The system as claimed in claim 13, wherein the response generated for said each entity from the plurality of entities is further provided by the output unit [108] in an augmented reality environment via the scrollable segment for said each entity from the plurality of entities.

23. The system as claimed in claim 13, wherein the input unit [102] is further configured to receive, one or more user identification parameters.

24. The system as claimed in claim 23, wherein the processing unit [106] is further configured to create, a mannequin for the user based on the one or more user identification parameters, wherein the mannequin is created on the user interface.

25. The system as claimed in claim 24, wherein the response for said each entity from the plurality of entities is further provided by the output unit [108] via the mannequin.
